(19) United States
(12) Patent Application Publication
(10) Pub. No.: US 2024/0211091 A1
(43) Pub. Date: Jun. 27, 2024

(54) APPLICATION-FREE SYSTEMS AND METHODS

(71) Applicant: Apple Inc., Cupertino, CA (US)

(72) Inventors: Michael J. ROCKWELL, Palo Alto, CA (US); Bradley W. PEEBLER, Redwood City, CA (US); Jeffrey S. NORRIS, Saratoga, CA (US)

(21) Appl. No.: 18/288,573

(22) PCT Filed: May 27, 2022
(86) PCT No.: PCT/US2022/031472

§ 371 Date: Oct. 26, 2023

Related U.S. Application Data
(60) Provisional application No. 63/197,233, filed on Jun. 4, 2021.

(51) Int. Cl. G06F 3/04815; G06T 19/00

(52) U.S. Cl. CPC G06F 3/04815; G06T 19/00; G06T 2200/24

(57) ABSTRACT

Implementations of the subject technology provide application-free extended reality systems and methods. In an application-free extended reality environment, data may be visualized for a user using a data visualization utility that is provided by an operating system of a computing device. The operating system can also provide, separately from the data visualization utility, interaction tools for interacting data that is displayed in the mixed reality environment by the data visualization utility.

### CROSS REFERENCE TO RELATED APPLICATIONS

This application claims the benefit of priority to U.S. Provisional Patent Application No. 63/197,233, entitled, “Application-Free Extended Reality Systems and Methods”, filed on Jun. 4, 2021, the disclosure of which is hereby incorporated herein in its entirety.

### TECHNICAL FIELD

The present description relates generally to providing extended reality environments, including, for example, application-free extended reality systems and methods.

### BACKGROUND

Electronic devices can provide combinations of virtual environments and a physical environment to enhance a user's perception of a physical environment by augmentation with computer-generated information. The computer-generated information can be displayed to appear as part of the physical environment as perceived by a user. Extended reality environments are typically provided by traditional application-based computing systems in which a user can only interact with data by accessing the data with an application and using the data within the physical and functional boundaries of that application.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with one or more implementations.

FIG. 2 illustrates an example of a physical environment of an electronic device in accordance with one or more implementations of the subject technology.

FIG. 3 illustrates an example of an extended reality environment that can be provided by an electronic device in accordance with one or more implementations of the subject technology.

FIG. 4 illustrates an example of an extended reality environment in which multiple interaction tools are provided in accordance with one or more implementations of the subject technology.

FIG. 5 illustrates an example of an extended reality environment in which multiple sets of interaction tools are provided in accordance with one or more implementations of the subject technology.

FIG. 6 illustrates an example of an extended reality environment in which data is visualized using a data visualization tool provided by an operating system of an electronic device in accordance with one or more implementations of the subject technology.

FIG. 7 illustrates an example of an extended reality environment including an interaction tool and in which multiple types of data are visualized using a data visualization tool provided by an operating system of an electronic device in accordance with one or more implementations of the subject technology.

FIG. 8 illustrates a schematic diagram of an electronic device in accordance with one or more implementations of the subject technology.

FIG. 9 illustrates an example of an extended reality environment in which multiple sets of interaction tools are provided in corresponding virtual toolboxes in accordance with one or more implementations of the subject technology.

FIG. 10 illustrates an example of a transition between extended reality environments that include corresponding sets of interaction tools in accordance with one or more implementations of the subject technology.

FIG. 11 illustrates a flow chart of an example process for providing operating an electronic device in accordance with one or more implementations of the subject technology.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

People may sense or interact with a physical environment or world without using an electronic device. Physical features, such as a physical object or surface, may be included within a physical environment. For instance, a physical environment may correspond to a physical city having physical buildings, roads, and vehicles. People may directly sense or interact with a physical environment through various means, such as smell, sight, taste, hearing, and touch. This can be in contrast to an extended reality (XR) environment that may refer to a partially or wholly simulated environment that people may sense or interact with using an electronic device. The XR environment may include virtual reality (VR) content, mixed reality (MR) content, augmented reality (AR) content, or the like. Using an XR system, a portion of a person's physical motions, or representations thereof, may be tracked and, in response, properties of virtual objects in the XR environment may be changed in a way that complies with at least one law of nature. For example, the XR system may detect a user's head movement and adjust auditory and graphical content presented to the user in a way that simulates how sounds and views would change in a physical environment. In other examples, the XR system may detect movement of an electronic device (e.g., a laptop, tablet, mobile phone, or the like) presenting the XR environment. Accordingly, the XR system may adjust auditory and graphical content presented to the user in a way that simulates how sounds and views would change in a physical environment. In some instances, other inputs, such as a representation of physical motion (e.g., a voice command), may cause the XR system to adjust properties of graphical content.

Numerous types of electronic systems may allow a user to sense or interact with an XR environment. A non-exhaustive list of examples includes lenses having integrated display capability to be placed on a user's eyes (e.g., contact lenses), heads-up displays (HUDs), projection-based systems, head mountable systems, windows or windshields having integrated display technology, headphones/earphones, input systems with or without haptic feedback (e.g., handheld or wearable controllers), smartphones, tablets, desktop/laptop computers, and speaker arrays. Head mountable systems may include an opaque display and one or more speakers. Other head mountable systems may be configured to receive an opaque external display, such as that of a smartphone. Head mountable systems may capture images/video of the physical environment using one or more image sensors or capture audio of the physical environment using one or more microphones. Instead of an opaque display, some head mountable systems may include a transparent or translucent display. Transparent or translucent displays may direct light representative of images to a user's eyes through a medium, such as a hologram medium, optical waveguide, an optical combiner, optical reflector, other similar technologies, or combinations thereof. Various display technologies, such as liquid crystal on silicon, LEDs, uLEDs, OLEDs, laser scanning light source, digital light projection, or combinations thereof, may be used. In some examples, the transparent or translucent display may be selectively controlled to become opaque. Projection-based systems may utilize retinal projection technology that projects images onto a user's retina or may project virtual content into the physical environment, such as onto a physical surface or as a hologram.

Implementations of the subject technology described herein provide an application-free environment with an electronic device, in which interaction tools for interacting with various types of data are provided by the operating system of the device and separately from any individual application. In one or more implementations, the interaction tools can be provided in an extended reality (XR) environment, such as a virtual reality environment or a mixed reality environment.

The operating system can provide, separately from the interaction tools, a utility that can be used to visualize data of any of the various data types. In one or more operational scenarios, multiple available interaction tools can be presented to the user concurrently for interaction with the data, before and/or while the data is being visualized in the visualization utility.

One illustrative example of an interaction tool is a virtual marker that can be used to annotate an image that is displayed in one part of an extended reality environment, to handwrite data into a cell of spreadsheet that is displayed in another part of an extended reality environment, and/or to handwrite input to an canvas provided by the operating system or the data visualization utilities. Other examples of interaction tools that can be provided by the operating system (e.g., and before or while any associated data is displayed) include a virtual credit card that can be used to make purchases when purchasable content is later displayed by the visualization utility, a virtual gaming controller that can be used for controlling gaming content that is later displayed by the visualization utility, or a virtual play button that can be used for controlling media playback of media content that is later displayed by the visualization utility.

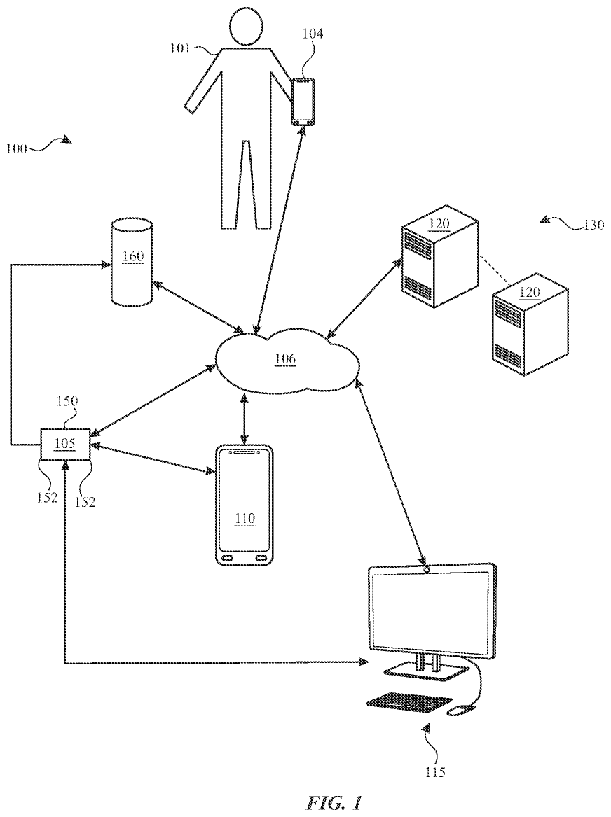

FIG. 1 illustrates an example system architecture 100 including various electronic devices that may implement the subject system in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, a smart speaker device 160, and a server 120. For explanatory purposes, the system architecture 100 is illustrated in FIG. 1 as including the electronic device 105, the handheld electronic device 104, the electronic device 110, the electronic device 115, the smart speaker device 160, and the server 120; however, the system architecture 100 may include any number of electronic devices, and any number of servers or a data center including multiple servers. In some implementations, the electronic device 105, the handheld electronic device 104, the electronic device 110, the electronic device 115, and/or the smart speaker device 160 may be registered to and/or associated with a same user account, such as via the server 120.

The electronic device 105 may be, for example, a smart phone, a tablet device, or a head mountable portable system, worn by a user, that includes a display system capable of presenting a visualization of an extended reality environment to the user (e.g., a head mountable display device). The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In one or more implementations, instead of, or in addition to, utilizing the electronic device 105 to access an extended reality environment, the user may use a handheld electronic device 104, such as a tablet, watch, mobile device, and the like.

The electronic device 105 may include one or more cameras such as camera(s) 150 (e.g., visible light cameras, infrared cameras, etc.) Further, the electronic device 105 may include various sensors 152 including, but not limited to, cameras, image sensors, touch sensors, microphones, inertial measurement units (IMU), heart rate sensors, temperature sensors, Lidar sensors, time-of-flight sensors, radar sensors, sonar sensors, GPS sensors, Wi-Fi sensors, near-field communications sensors, radio frequency sensors, eye-tracking sensors, etc. Moreover, the electronic device 105 may include hardware elements that can receive user input such as hardware buttons or switches. User input detected by such sensors and/or hardware elements correspond to various input modalities for initiating generating supplemental virtual content within a given extended reality environment. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. The electronic device 105 may also detect a presence of a person, object, device, and/or an occurrence of an event in a scene to initiate providing or modify virtual content within the extended reality environment.

The electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 while physically connected).

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an implementation, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner. In an example, the electronic device 105 provides a rendering of a scene corresponding to the extended reality environment that can be perceived by the user and interacted with in a real-time manner. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload.

The network 106 may communicatively (directly or indirectly) couple, for example, the electronic device 105, the electronic device 110, the smart speaker device 160, and/or the electronic device 115 with each other device and/or the server 120. In one or more implementations, the network 106 may be an interconnected network of devices that may include, or may be communicatively coupled to, the Internet.

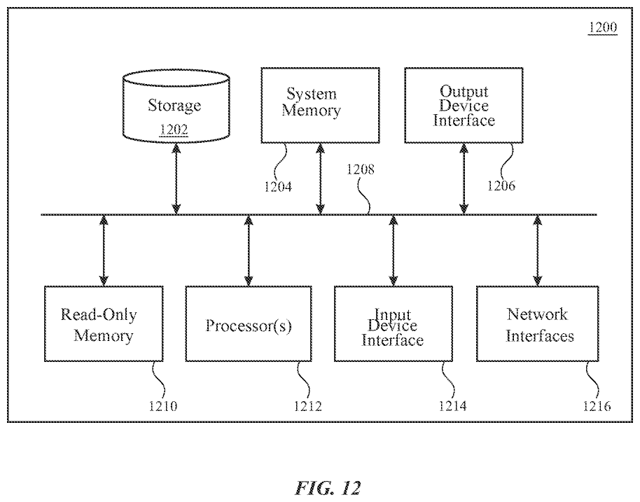

The electronic device 110 may include a touchscreen and may be, for example, a smartphone that includes a touchscreen, a portable computing device such as a laptop computer that includes a touchscreen, a peripheral device that includes a touchscreen (e.g., a digital camera, headphones), a tablet device that includes a touchscreen, a wearable device that includes a touchscreen such as a watch, a band, and the like, any other appropriate device that includes, for example, a touchscreen, or any electronic device with a touchpad. In one or more implementations, the electronic device 110 may not include a touchscreen but may support touchscreen-like gestures, such as in an extended reality environment. In one or more implementations, the electronic device 110 may include a touchpad. In FIG. 1, by way of example, the electronic device 110 is depicted as a mobile smartphone device with a touchscreen. In one or more implementations, the electronic device 110, the handheld electronic device 104, and/or the electronic device 105 may be, and/or may include all or part of, the electronic device discussed below with respect to the electronic system discussed below with respect to FIG. 12. In one or more implementations, the electronic device 110 may be another device such as an Internet Protocol (IP) camera, a tablet, or a peripheral device such as an electronic stylus, etc.

The electronic device 115 may be, for example, desktop computer, a portable computing device such as a laptop computer, a smartphone, a peripheral device (e.g., a digital camera, headphones), a tablet device, a set-top box configured to interface with an external display such as a television, a wearable device such as a watch, a band, and the like. In FIG. 1, by way of example, the electronic device 115 is depicted as a desktop computer. The electronic device 115 may be, and/or may include all or part of, the electronic system discussed below with respect to FIG. 12.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an implementation, the server 120 may function as a cloud storage server that stores any of the aforementioned extended reality content generated by the above-discussed devices and/or the server 120, and/or information for generating/rendering such content.

Smart speaker device 160 may include one or more microphones for accepting audio (e.g., voice) input, one or more acoustic devices such as speakers, communications circuitry for communicating with electronic device 110, electronic device 115, network 106, electronic device 105, and/or handheld electronic device 104, memory for storing information and/or code for one or more applications, and/or processing circuitry. The smart speaker device 160 may be, and/or may include all or part of, the electronic system discussed below with respect to FIG. 12.

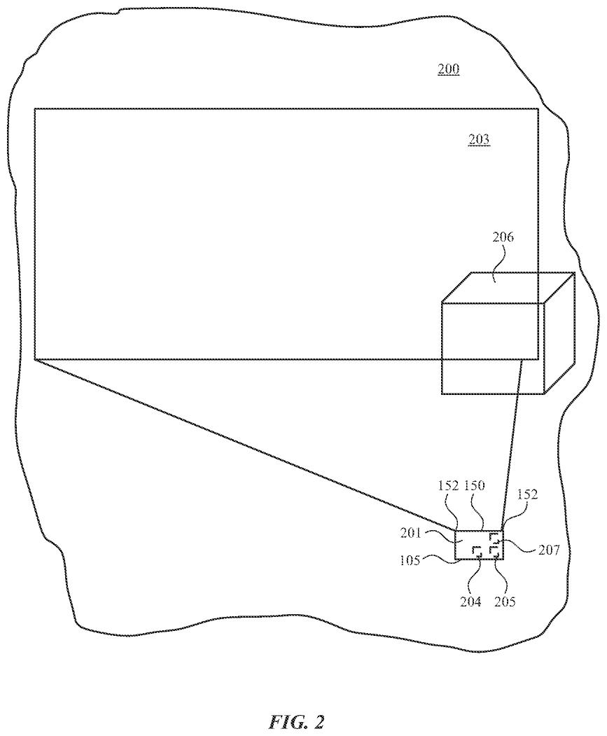

FIG. 2 illustrates an example of a physical environment in which an electronic device 105 is provided. In the example of FIG. 2, a user may hold or wear an electronic device 105 in a physical environment 200, such that a display 201 of the electronic device is interposed between the user's view and a substantial portion of the physical environment 200 (e.g., as illustrated in the figure by the enlarged projection of the viewable display area 203 of the display 201). The physical environment 200, in the example of FIG. 2, includes a physical object 206, a portion of which can be viewed by user 101 via display 201 (e.g., based on images (from one or more cameras such as camera(s) 150) that are provided to an opaque implementation of display 201 or directly through a transparent or translucent implementation of display 201) and portions of which can be viewed directly by the user without the use of any technology (if not otherwise blocked from view). FIG. 2 also illustrates how the electronic device 105 may store data 204, a data visualization utility 205 for visualizing various types of the data 204, and one or more interaction tool sets 207 that can be provided by an operating system of the electronic device to facilitate user interaction with the device and/or the data 204.

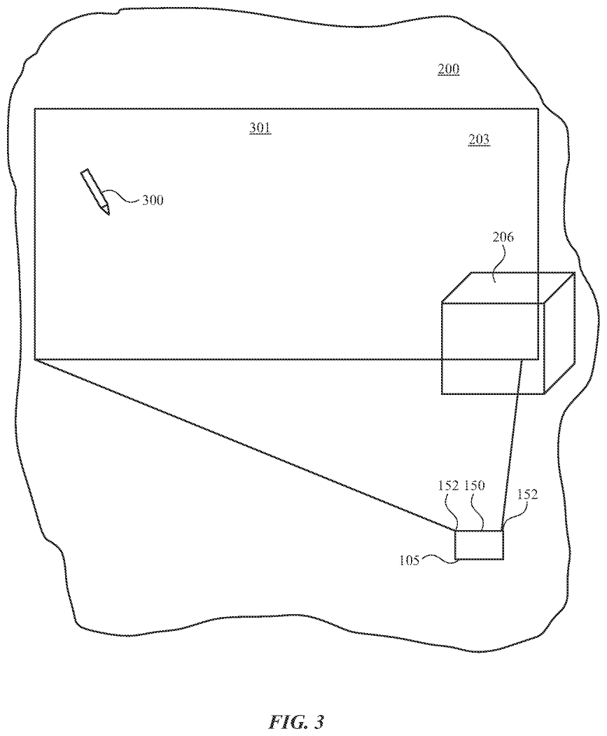

FIG. 3 illustrates an XR environment 301 (e.g., a virtual reality environment, or a mixed-reality environment, such as a two-dimensional mixed-reality environment or a three-dimensional mixed-reality environment) generated by the electronic device 105 in the physical environment 200 (e.g., within the viewable display area 203 of the electronic device 105). In the example of FIG. 3, computer-generated content is being displayed by display 201 (e.g., within the viewable display area 203 overlaid on or in front of portions of physical environment 200) in an XR environment. In this example, the computer-generated content is a virtual marker 300 that is displayed by the display 201 of the electronic device 105 to appear in the viewable display area 203 at a three-dimensional location in the physical environment 200.

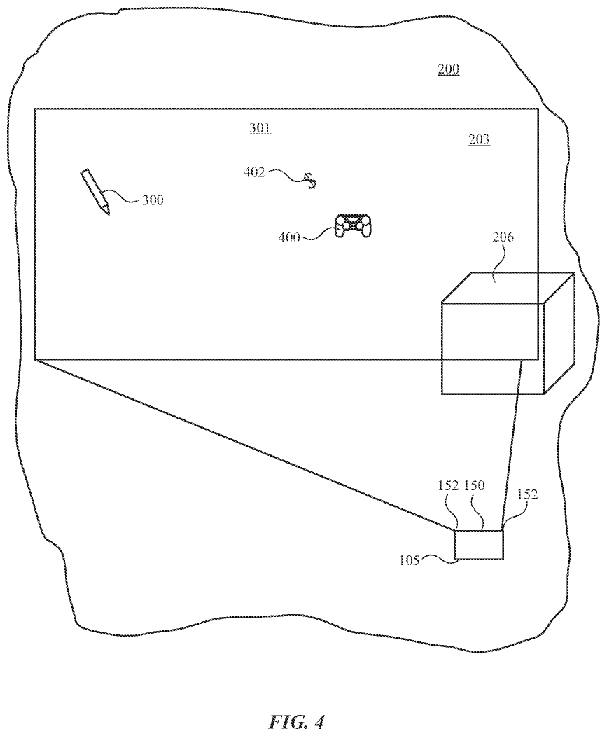

FIG. 4 illustrates the XR environment 301 of FIG. 3 with additional interaction tools displayed in the XR environment. In the example of FIG. 3, the additional interaction tools include a virtual gaming controller 400 and a virtual payment tool 402 (displayed in the form of a virtual dollar sign in FIG. 4 as an example, or displayable in the form of a virtual credit card, or other virtual payment tool). In one or more implementations, the virtual marker 300 may be provided by a first interaction tool provider, and the virtual gaming controller 400 and the virtual payment tool 402 may be provided by a second interaction tool provider. In one or more implementations, the first interaction tool provider and/or the second interaction tool provider may be different from a manufacturer of the electronic device 105 and/or a provider of an operating system of the electronic device 105. For example, the virtual marker 300 may be provided by a provider of interaction tools for interacting with data such as text data, image data or the like. For example, the virtual gaming controller 400 may be provided by a provider of gaming content.

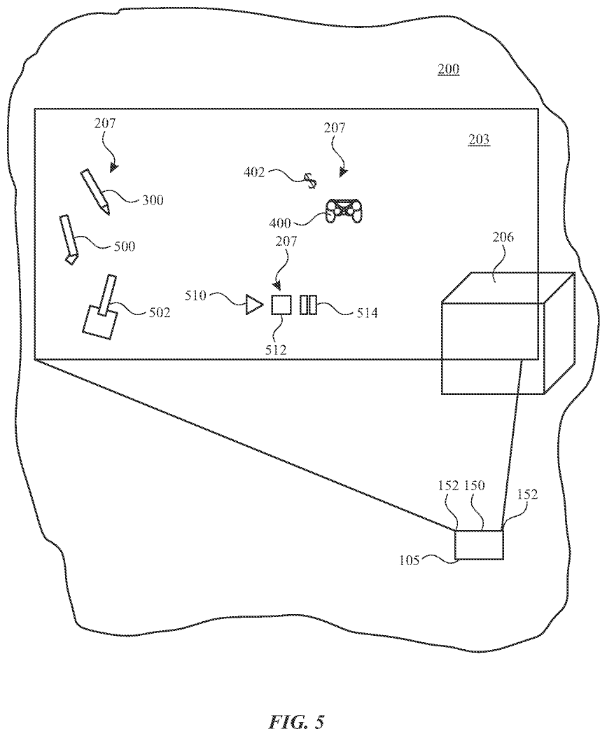

In one or more implementations, interaction tools, such as the virtual marker 300, and the virtual gaming controller 400 and the virtual payment tool 402, may be provided in corresponding sets of interaction tools (also referred to herein as interaction tool sets). For example, FIG. 5 illustrates an operational scenario in which additional interaction tools such as a virtual highlighter 500 and a virtual paintbrush 502 are displayed along with the virtual marker 300. In one or more implementations, a provider of interaction tools for interacting with text data or image data may provide a set of interaction tools that includes the virtual marker 300, the virtual highlighter 500, the virtual paintbrush 502, and/or other interaction tools that can be used to interact with text data and/or image data (e.g., virtual scissors, virtual paste, virtual filters, and/or image enhancement and/or adjustment tools such as a virtual color slider, contrast slider, brightness slider, or the like).

In the example of FIG. 5, an additional interaction tool set 207 of interaction tools is also displayed by the display 201. In this example, the additional interaction tool set 207 of interaction tools includes a virtual play button 510, a virtual stop button 512, and a virtual pause button 514. It is appreciated that, in the example of FIG. 5, the virtual play button 510, the virtual stop button 512, and the virtual pause button 514 are provided and displayed by the operating system of the electronic device 105 at a time when no application is running on the electronic device, and no media data has been selected or displayed for playback using the virtual play button 510, the virtual stop button 512, and the virtual pause button 514. When media data is accessed (e.g., and/or visualized in the XR environment 301), the virtual play button 510, the virtual stop button 512, and the virtual pause button 514 that were previously displayed can be used to control the accessed media data. In this way, the operating system of the electronic device 105 provides media interaction tools that can be used to control playback of media of any type and from any source, without requiring a type-specific application to access, visualize, and playback the media. In one or more implementations, interaction tools, such as the virtual play button 510, the virtual stop button 512, the virtual pause button 514 and/or other media control tools (e.g., a virtual volume control, or a virtual rewind or fast-forward button and/or slider), can be provided in any environment that can be provided by the electronic device 105, and/or can be provided in a media viewing XR environment (e.g., an XR environment in which video data is displayed in a virtual movie theater).

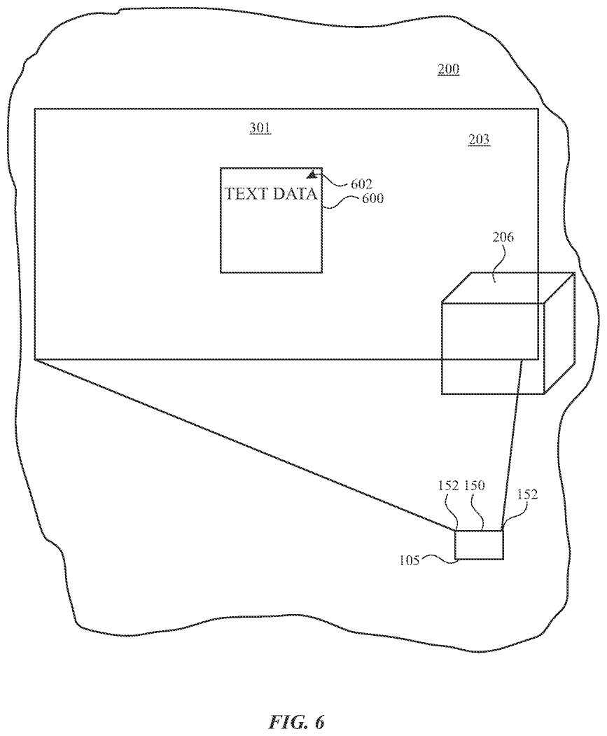

FIG. 6 illustrates an example in which the data visualization utility 205 is being used to visualize text data 602 in a visualization window 600 in the XR environment 301. The visualization window 600 may be a bordered window as in the figure, or can be a borderless region in the XR environment 301 in various implementations. In other operational scenarios, the data visualization utility 205 may be used to visualize other types of data (e.g., image data, CSV data, text data, media data such as audio and/or video data, game data, shopping data, scene description data such as USDZ data, etc.), as described herein. As shown in FIG. 6, in one or more operational scenarios, the visualization window 600 of the data visualization utility 205 can be used to display and or visualize data such as text data 602, at a time when no interaction tools are displayed in the mixed reality environment. In various operational scenarios, the data visualization utility 205 can be used to visualize data before, while, or after interaction tools have been displayed in the mixed reality environment.

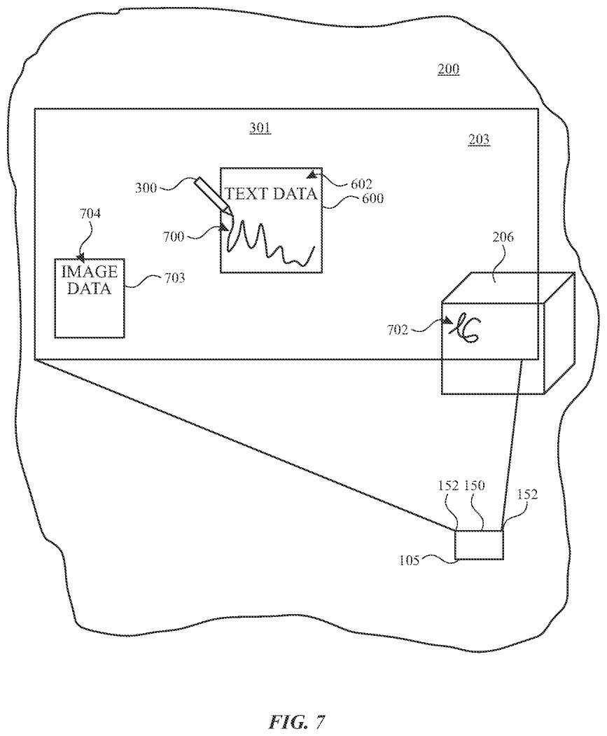

FIG. 7 illustrates an operational scenario in which the data visualization utility 205 and the virtual marker 300 are both displayed concurrently in the mixed reality environment. In this example, the virtual marker 300 has been used to provide handwritten input 700 into a display window of the data visualization utility 205, along with the text data 602 being displayed by the data visualization utility 205. For example, the handwritten input may be an annotation to the text data 602 or additional handwritten text that can be stored with the previously existing text data in a data file. In the example of FIG. 7, the virtual marker 300 has also been used to provide handwritten input (e.g., a doodle 702), that appears to be located on the physical object 206 in the XR environment 301. In one or more implementations, the doodle 702 can be erased from the memory of the electronic device after the XR environment is no longer in use, or the doodle 702 can be stored (e.g., in environment data for the XR environment 301) as part of the XR environment 301 for future experiences in the XR environment 301.

This example illustrates how an interaction tool that is provided by an operating system of an electronic device such as electronic device 105 can be provided independently of any application, and can be used for interaction with various types of data (e.g., text data and environment data such as scene data) displayed at various different locations in a mixed reality environment. In the example of FIG. 7, the data visualization utility 205 visualizes the text data 602 (e.g., in a first data visualization window) at a first location in the XR environment 301, and the data visualization utility 205 is also being used to visualize different data, such as image data 704, in a different visualization window 703 at a different location in the XR environment 301. In this example, if desired, a user of the electronic device 105 may also use the virtual marker 300, or another interaction tool provided by the operating system of electronic device 105, to provide handwritten input onto or into the image data 704 displayed at the other location in the mixed reality environment 301.

In the example of FIG. 7, and various other examples described herein, a virtual marker 300 and other virtual interaction tools are described. It is appreciated that one or more of the interaction tools that is displayed in an extended reality environment may be rendered and displayed with a three-dimensional appearance, in the three-dimensional extended reality environment, that corresponds to a physical shape of a corresponding physical tool. For example, although the virtual marker 300 is shown in two dimensions in various figures, it is appreciated that the display 201, and the operating system of electronic device 105, are capable of displaying the virtual marker 300 to appear to the user of the electronic device 105 as though the virtual marker 300 is a three-dimensional physical marker in the extended reality environment. In this way, a user of the electronic device 105 can be provided with the ability to interact with a virtual interaction tool as the user would interact with a corresponding physical tool.

In the example of FIG. 7, the user of electronic device 105 can, for example, reach out with their hand and virtually grasp the virtual marker 300 and use the virtual marker to write on any virtual or real physical object in the XR environment 301, just as the user could use a physical marker in the physical environment 200 to write on (as examples) a piece of paper, a white board, a photograph, or a wall in the physical environment. In contrast with application-based systems (in which all of the tools for operating on a particular type of data are provided by and confined to the application being used to display that data), the operating-system-provided interaction tools described herein spatially and functionally free the interaction tools from being restricted to use within a particular application window, and allow the user to more intuitively interact with the tools, various types of data, and the extended reality environment itself, in a way that more closely matches the user's experience in the physical world.

FIG. 7 also illustrates how interaction tools such as the virtual marker 300 may be represented by a graphical icon that can be picked up, moved, placed, stored and/or otherwise manipulated by the user within a (e.g., three-dimensional) space that includes a region (e.g., an area or a volume) away from and separate from the data visualization tool itself and/or data being visualized by the data visualization tool.

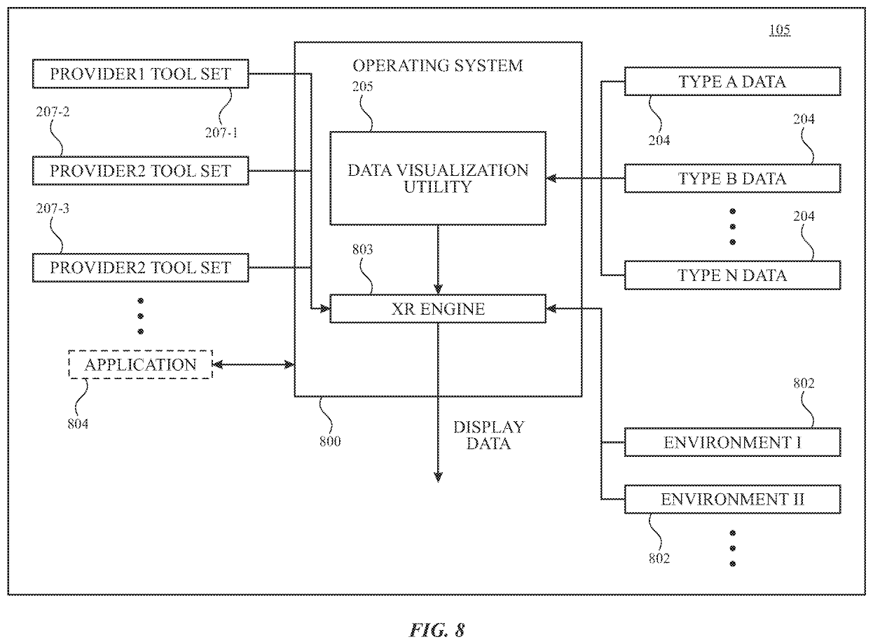

FIG. 8 illustrates a schematic diagram of the electronic device 105, in accordance with one or more implementations. As shown in the example of FIG. 8, the electronic device 105 may store various types of data 204. In this example, the data 204 includes type A data (e.g., image data), type B data (e.g., media data such as audio and/or video data), type N data (e.g., gaming data), and/or any other type of data than can be stored and/or displayed by a computing device (e.g., including spreadsheet data such as comma-separated value (CSV) data or other tabular data, programming data, text data, shopping data, etc.).

In the example of FIG. 8, the electronic device 105 also stores environment data 802 for generating one or more XR (e.g., virtual and/or mixed reality) environments (e.g., including XR environment 301) using the display 201. For example, the electronic device 105 may store environment I data for a first environment (e.g., a first extended reality environment such as a productivity environment that includes a virtual work table or desk and a virtual a white board, or other environmental features and/or characteristics for enhancing productivity), environment data II for a second environment (e.g., an arcade environment in which various games are available for play), and/or other environment data for other XR environments, such as a shopping environment in which products are displayed for purchase, or a social media environment in which social media streams from various sources are available and/or displayed. In one or more implementations, the environment data 802 may include scene description data (e.g., USDZ data) for one or scenes associated with one or more environments.

In one or more implementations, the environment data 802 may be or include physical environment data (e.g., as determined by the electronic device 105 based on sensor data such as camera data, Lidar data, range sensor data, or other sensor data from sensors that sense features of the physical environment). In these exemplary implementations, an environment type, and/or environment features and/or objects, may be determined from the sensor data, and used to inform which provider tool sets are presented and/or how and/or where in the user's (e.g., pass-through or direct) view of the physical environment the tool(s) of the provider tool sets are presented. For example, the electronic device 105 may provide a pass-through video view of the physical environment for presentation to the user or the user may be able to directly view a portion of the physical environment, such as through a transparent display. The electronic device 105 may also, in some examples, determine a physical environment type (e.g., a work environment, a home environment, a gaming environment, a shopping environment) based on detected features and/or objects in the physical environment, select one or more provider tool sets that is/are relevant to that detected physical environment, and provide the selected one or more provider tool sets for presentation to the user overlayed on the user's (e.g., pass-through or direct) view of the physical environment.

As shown in FIG. 8, the operating system 800 may provide an XR engine 803 that may obtain the environment data 802 and generate, pass through, and/or render scene data for an extended reality environment (e.g., XR environment 301). As shown in FIG. 8, operating system 800 may also provide the data visualization utility 205. As shown, the data visualization utility 205 may (e.g., responsive to activation by a user) access data 204 of any type and provide the data to XR engine 803 for rendering and generation of display data for display (e.g., by display 201 in an XR environment generated by XR engine 803 using the environment data 802).

FIG. 8 also illustrates how the electronic device 105 may store one or more interaction tool sets 207, each of which may include one or more interaction tools as described herein. In the example, of FIG. 8, the electronic device 105 stores a first interaction tool set 207-1, a second interaction tool set 207-2, a third interaction tool set 207-3, and/or one or more additional sets of interaction tools. In this example, the first interaction tool set 207-1 is a tool set from a first provider (e.g., “provider1”, such as a software provider other than a provider of the operating system 800), the second set 207-2 is a tool set from a second provider (e.g., “provider2” such as a software provider other than a provider of the operating system 800), and the third second set 207-3 is a tool set from a third provider (e.g., “provider3” such as a provider of the operating system 800). Although three sets of interaction tools, environment data 802 for two environments, and N data types are illustrated in FIG. 8, the electronic device 105 may store and/or access any number of interaction tool sets, environment data for any number of environments, and/or any number of types of data 204. It is also appreciated that an interaction tool set may include one interaction tool, two interaction tools, three interaction tools, four interaction tools, or any number of interaction tools, and that interaction tools can be added and/or removed from a set of interaction tools by a user and/or by the operating system 800.

In one or more implementations, the interaction tool sets 207 may be independent of the data types of the data 204 and the XR environments of the environment data 802. In one or more other implementations, an interaction tool set 207 may be provided specifically or primarily for use with a specific type of data or a group of data types. In one or more other implementations, an interaction tool set 207 may be provided specifically or primarily for use in a specific XR environment or a group of XR environments.

In one or more implementations, electronic device 105 may be an application-free electronic device that provides a full set of interaction and other computing capabilities via the single data visualization utility 205, the operating system 800, and the interaction tool sets 207 that are provided by the operating system. However, as shown in FIG. 8, in one or more implementations, the electronic device 105 may optionally include one or more applications, such as application 804, in addition to the data visualization utility 205. For example, the application 804 may be a gaming application that utilizes the environment data 802 and/or the data 204 to providing a gaming experience to user. In this example, the operating system 800 (e.g., XR engine 803) may render and display gaming data generated by the gaming application, and may also render one or more interaction tools that are provided by the operating system 800 separately from the gaming application. In the example, gaming data and the interaction tools from the operating system may be rendered into a common gaming environment in which the user can utilize the interaction tools provided by the operating system for interaction with rendered gaming data from the gaming application. However, in other implementations, the data visualization utility 205 can render and display gaming data to provide a gaming experience to a user without the use of a gaming application.

In various implementations in which the electronic device 105 includes applications such as applications 804, one or more interaction tools of one or more sets 207 of interaction tools may be used to interact with (e.g., edit, modify, supplement, delete) data generated by, displayed by, and/or otherwise provided by any or all of the applications (e.g., including data displayed at various times or concurrently by multiple different applications).

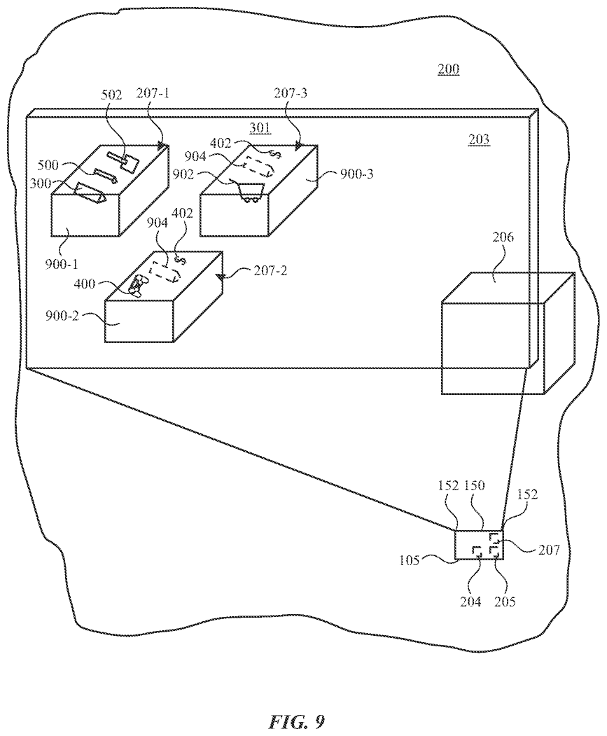

In one or more implementations, the operation system 800 of electronic device 105 may display one or more toolboxes in which interaction tools from the interaction tool sets 207 may be visually “stored”. FIG. 9 illustrates an example, in which interaction tools in each of the interaction tool sets 207-1, 207-2, and 207-3 of FIG. 8 are displayed in connection with a respective virtual toolbox 900-1, 900-2, and 900-3.

In the example of FIG. 9, the first interaction tool set 207-1 of interaction tools includes the virtual marker 300, the virtual highlighter 500, and the virtual paintbrush 502, which are visually positioned in the corresponding virtual toolbox 900-1 (e.g., a productivity toolbox). In this example, the second interaction tool set 207-2 of interaction tools includes the virtual gaming controller 400, and the virtual payment tool 402, which are visually positioned in the corresponding virtual toolbox 900-2 (e.g., a gaming toolbox). In this example, the third interaction tool set 207-3 of interaction tools includes the virtual payment tool 402 and a virtual shopping cart 902, which are visually positioned in the corresponding virtual toolbox 900-3 (e.g., a shopping toolbox). As shown, the virtual payment tool 402 may be included in more than one toolbox and more than one set of interaction tools. In other implementations, the operating system 800 may provide a single virtual payment tool 402 (or a single set of payment tools such as virtual cash linked to a bank account, and virtual credit card linked to a payment card account) that can be used in any environment and/or that can be virtually stored in any toolbox.

As shown in the example of FIG. 9, one or more tool boxes such as virtual tool boxes 900-2 and 900-3 may include one or more empty tool locations 904. Empty tool locations 904 may have shape that corresponds to an interaction tool that has been removed from the empty tool location, or that can be purchased and/or obtained for download for use in an XR environment. For example, the empty tool locations 904 can indicate, to the user, other interaction tools that may be available for purchase. In the example of FIG. 9, both of virtual toolbox 900-2 and virtual toolbox 900-3 include an empty tool location 904 in the shape of virtual marker 300. In one or more implementations, the same virtual marker 300 may be included and/or storable in more than one of the interaction tool sets 207 of interaction tools. In one or more other implementations, two or more of the interaction tool sets 207 of interaction tools may be provided with two or more respective virtual markers that are unique to that tool set. In one or more other implementations, some interaction tools may fit in multiple virtual toolboxes and some interaction tools may fit in only in one virtual toolbox.

In the example of FIG. 9, both of the virtual toolboxes 900-2 and 900-3 include a virtual payment tool 402. In this example, each of the virtual payment tools 402 in each of the corresponding interaction tool sets 207 of interaction tools may include a corresponding virtual payment tool 402 that is linked to one or more payment providers (e.g., a bank, a credit card provider, etc.). However, in one or more other implementations, the operating system 800 may provide one or more virtual payment tools 402 that are each linked to a payment provider and that can each be used across multiple content types, multiple interaction tool sets 207, and/or multiple XR environments.

In one or more implementations, interaction tool sets 207 can be provided for interaction with a particular type of data 204 or for groups of data types. Illustrative examples of tools sets corresponding to a data type include: a pen, a filter set, and contrast/brightness sliders for interacting with image data; a pen and a selection tool for interacting with tabular data; a pen, a marker, a selection tool, and a virtual keyboard for interacting with text data; a play button, a stop button, and a pause button for interacting with media data; a joystick/controller, a rope, and a ladder for interacting with gaming data; and a wallet, a credit card, and a shopping cart for interacting with shopping data. However, these examples are merely illustrative and the operating system 800 may provide any number of suitable interaction tools for interaction with any of one or more types of data.

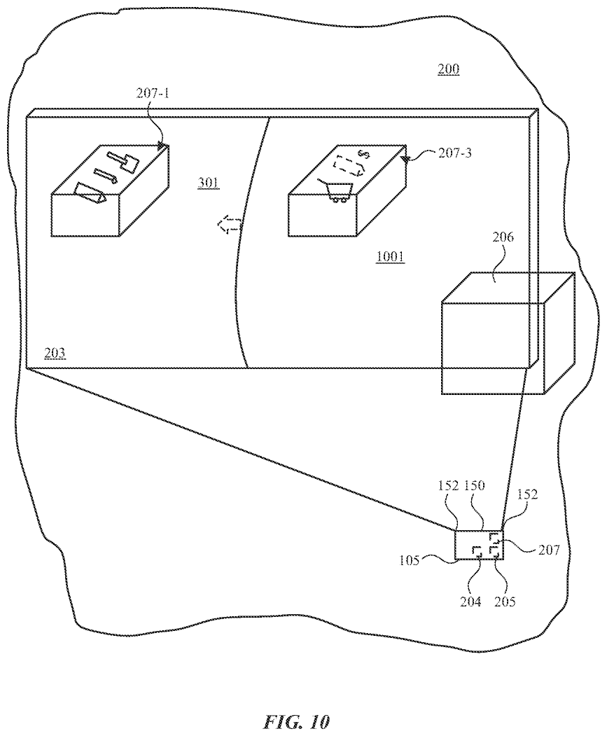

In one or more implementations, interaction tool sets 207 can be provided for use in a corresponding environment (e.g., a corresponding XR environment and/or a corresponding physical environment). As an illustrative example, FIG. 10 illustrates a scenario in which a user is transitioning the electronic device 105 from one XR environment 301 (e.g., a productivity environment) to another XR environment 1001 (e.g., a shopping environment). In the example of FIG. 10, the user may be inputting a gesture from right to left (e.g., in the direction of the dashed arrow) to slide from the XR environment 301 to the XR environment 1001. However, this is merely illustrative, and various other transitions between XR environments can be provided by the electronic device 105 responsive to various other user inputs. In other examples, the user of the electronic device 105 may physically transition between physical environments, and the physical transition can also be detected by the electronic device 105. For example, the user may move from an office to a home, from a home office to a living room in the same home, from a home to a gym or a playing field, etc. In one or more implementations, each of several XR environments and/or physical environments may be associated with one or more corresponding interaction tool sets 207.

In the example of FIG. 10, the electronic device 105 has included, in the XR environment 301 (e.g., the productivity environment), a corresponding interaction tool set 207-1 (e.g., including interaction tool such as a marker, a highlighter, and a paintbrush) for use in the productivity environment. FIG. 10 also shows how electronic device 105 may provide a different corresponding interaction tool set 207-3 (e.g., including interaction tools such as a shopping cart and a payment tool) for use in the shopping environment.

For example, the shopping environment may be a virtual store in which the user of electronic device 105 can navigate through the virtual store to view virtual representations of products for sale. In one or more implementations, the electronic device 105 may provide the XR environment 1001 by obtaining environment data for the virtual store from a merchant server, and rendering the XR environment 1001 using the obtained environment data from the merchant server (e.g., with the data visualization utility 205 and/or the XR engine 803).

Separately from the data obtained from the merchant server, the electronic device 105 can provide the interaction tool set 207-3 for use in the rendered shopping environment. For example, rather than displaying a shopping cart and a payment button that are provided by the merchant server (e.g., as are sometimes provided on merchant web pages), the electronic device 105 (e.g., the operating system 800 of electronic device 105), can provide a shopping cart and a payment tool that can be used in the XR environment 1001 and that can also be used in any other environment, including environments not associated with the merchant server.

The interaction tool sets 207-1 and 207-3 shown in FIG. 10 may be provided specifically for the respective XR environments 301 and 1001 (which may be entirely virtual environments or which can be or include portions of a particular physical environment), or can be provided for multiple different environments or all environments that are available from the electronic device 105. The interaction tool sets 207-1 and 207-3 can be permanently included in a corresponding XR environment, or can be suggested (e.g., by the operating system to the user) for use in particular XR environments and also accessible by the user within other XR environments.

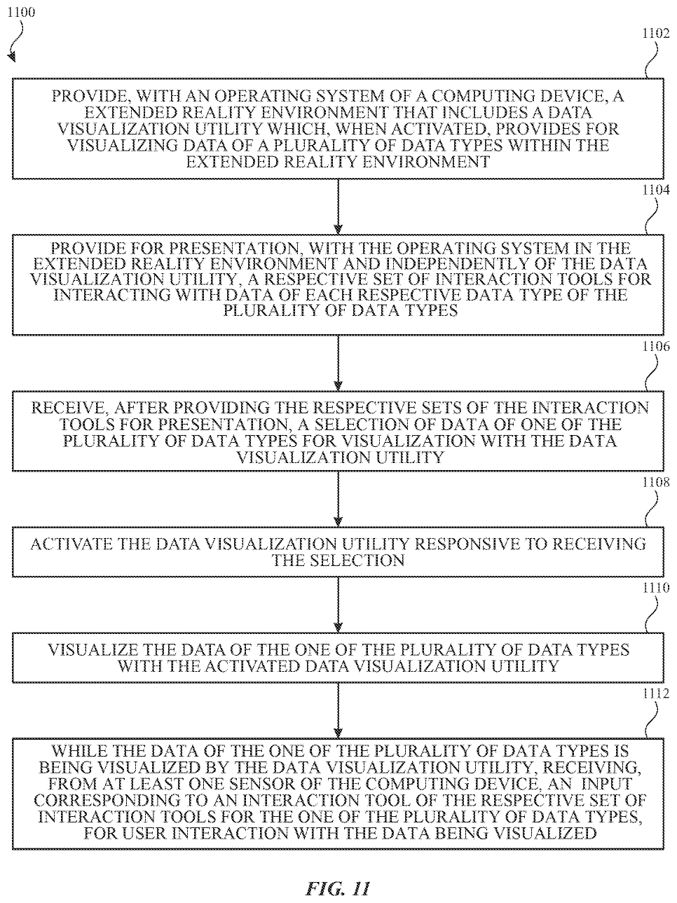

FIG. 11 illustrates a flow diagram of an example process 1100 for operating an electronic device, in accordance with one or more implementations of the subject technology. For explanatory purposes, the process 1100 is primarily described herein with reference to the electronic device 105 of FIG. 1. However, the process 1100 is not limited to the electronic device 105 of FIG. 1, and one or more blocks (or operations) of the process 1100 may be performed by one or more other components of other suitable devices, including the electronic device 110, the electronic device 115, and/or the servers 120. Further for explanatory purposes, some of the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

In the example of FIG. 11, at block 1102, an operating system of a computing device (e.g., an operating system of a computing device such as electronic device 105) provides an extended reality environment that includes a data visualization utility (e.g., data visualization utility 205) which, when activated, provides for visualizing data (e.g., data 204) of a plurality of data types (e.g., type A data, type B data, type N data) within the extended reality environment. For example, the extended reality environment may be a two-dimensional extended reality environment or a three-dimensional extended reality environment. In one or more implementations, the extended reality environment may be an application-free environment (e.g., an environment in which only the data visualization utility is available for visualization of data, and in which only operating system provided tools are available for interacting with the visualized data).

At block 1104, the operating system provides for presentation, in the extended reality environment and independently of the data visualization utility, a respective set of interaction tools (e.g., an interaction tool set 207) for interacting with data of each respective data type of the plurality of data types. In one or more implementations, more than one of the sets of interaction tools and more than one of the interaction tools in each set of interaction tools are selectable for concurrent presentation in the extended reality environment. In one or more implementations, first and second sets of the sets of interaction tools are, prior to the operating system providing the respective set of the interaction tools for interacting with the data of each respective data type of the plurality of data types for presentation, provided to the computing device, respectively, by first and second interaction tool providers, at least one of the first and second interaction tool providers being different from a provider of the operating system.

In one or more implementations, the interaction tool of the respective set of interaction tools for the one of the plurality of data types is a first interaction tool of the first set, and a second interaction tool of the second set is concurrently presented for use in interacting with the data of the one of the plurality of data types being visualized by the data visualization utility (e.g., as described above in connection with FIG. 5). In one or more implementations, the interaction tool of the respective set of interaction tools may be presented with a three-dimensional appearance in the three-dimensional extended reality environment, the three-dimensional appearance corresponding to a physical shape of a corresponding physical tool.

At block 1106, after providing the respective sets of the interaction tools for presentation, the operating system receives a selection of data of one of the plurality of data types for visualization with the data visualization utility. In one or more implementations, receiving the selection of the data of one of the plurality of data types may include receiving the selection with the interaction tool of the respective set of interaction tools. For example, a user holding a virtual marker, such as virtual marker 300, may use the virtual marker to select a document or an image that is stored at the electronic device (e.g., by pointing to, tapping, or otherwise gesturing in connection with an icon corresponding to a file storing the document or the image, with the virtual marker). In other implementations, the data for visualization can be selected without the use of an interaction tool (e.g., the user can point to, tap, or otherwise gesture in connection with an icon corresponding to the document or the image with their hand, or may select the data by gazing at the icon or using other eye-control gestures and/or movements). In one or more other operational scenarios, data can be selected for visualization prior to displaying any interaction tools (e.g., as described in connection with FIG. 6).

At block 1108, the operating system activates the data visualization utility responsive to receiving the selection.

At block 1110, the activated data visualization utility visualizes (e.g., renders and displays) the data of the one of the plurality of data types. As illustrative examples, the data visualization utility may visualize media data, gaming data, documents, images, text, or any other data that can be displayed by a computing device.

At block 1112, while the data of the one of the plurality of data types is being visualized by the data visualization utility, the operating system receives, from at least one sensor of the computing device, an input (e.g., a user input) corresponding to an interaction tool of the respective set of interaction tools for the one of the plurality of data types, for user interaction with the data being visualized. As an illustrative example, the input may include sensor data indicating a user gesture to grasp and move a virtual marker provided by the operating system to draw on an image displayed by the data visualization utility. As another illustrative example, the input may include sensor data indicating a user gesture to grasp and manipulate a virtual payment tool provided by the operating system to make a purchase of a product displayed by the data visualization utility. As another illustrative example, the input may include sensor data indicating a user gesture to virtually press a virtual play button provided by the operating system to start playback of media data displayed by the data visualization utility.

In one or more implementations, two or more of the interaction tools can be displayed concurrently. For example, the electronic device may concurrently present the interaction tool of the respective set of interaction tools and at least another of the interaction tools in the extended reality environment for modifying the data of the one of the plurality of data types being visualized by the data visualization utility. In one or more implementations, while visualizing the data of the one of the plurality of data types with the activated data visualization utility at a first location in the extended reality environment, the electronic device may also visualize data of another one of the plurality of data types with the data visualization utility at a second location in the extended reality environment (e.g., as described in connection with FIG. 7).

In one or more implementations, while the data of the one of the other one of the plurality of data types is being visualized by the data visualization utility at the second location, the electronic device may display an interaction tool of the respective set of interaction tools for the other one of the plurality of data types in the extended reality environment. In various operational scenarios, the interaction tool of the respective set of interaction tools for the other one of the plurality of data types may be the same as, or different from, the interaction tool of the respective set of interaction tools for the one of the plurality of data types. The electronic device may also receive a user selection of the interaction tool of the respective set of interaction tools for the other one of the plurality of data types (e.g., the user may use a hand gesture to virtually grasp the displayed interaction tool). The electronic device may also receive, from the at least one sensor, an input corresponding to an interaction, using the selected interaction tool of the respective set of interaction tools for the other one of the plurality of data types, with the data of the one of the other one of the plurality of data types that is being visualized by the data visualization utility at the second location (e.g., while grasping the selected interaction tool, the user may move or otherwise manipulate the interaction tool in the vicinity or the direction of the data to add additional data, remove data, modify the data, send the data to a remote device, or otherwise interact with the visualized data).

In one or more implementations, the computing device may also deactivate the data visualization utility (e.g., responsive to a user closing a corresponding visualization window), and remove the respective set of interaction tools from display in the extended reality environment. The computing device may also receive an additional selection of data of another one of the plurality of data types for visualization with the data visualization utility, activate the data visualization utility responsive to receiving the additional selection, visualize the data of the additional one of the plurality of data types with the activated data visualization utility, and provide at least one interaction tool for interaction with the data of the additional one of the plurality of data types after visualizing the data of the additional one of the plurality of data types with the activated data visualization utility. In this way, because the data visualization utility and the interaction tools are separately provided by the operating system (e.g., rather than the data access and the interaction tools both being provided by and confined to an application in an application-based system) data may also be visualized at a time when no interaction tools are displayed, in one or more implementations.

As described above, aspects of the subject technology can include obtaining and/or using data available from specific and legitimate sources for operating extended reality systems. The subject disclosure understands that in some instances, this data may include personal information that uniquely identifies or can be used to identify a specific person. Such information can include video data, three-dimensional geometry data, demographic data, location-based data, online identifiers, telephone numbers, gesture data, eye tracking data, email addresses, home addresses, biometric data or records relating to a user's health or level of fitness (e.g., vital signs measurements, medication information, exercise information), date of birth, or any other personal information.

The subject disclosure recognizes that the use of such information, in the present technology, can benefit users. For example, the personal information can be used for providing an application-free XR environment.

The subject disclosure understands that entities responsible for the collection, analysis, disclosure, transfer, storage, or other use of personal information will comply with well-established privacy policies and/or privacy practices. In particular, these entities would be expected to implement and consistently apply privacy practices that are generally recognized as meeting or exceeding industry or governmental requirements for maintaining the privacy of users. Such information regarding the use of personal data would be expected to be prominently and easily accessible by users, and updated as the gathering and/or usage of data changes. Personal information from users is expected to be collected for legitimate uses only. Further, such collection/sharing is expected to occur only after receiving consent of users or other legitimate basis specified in applicable law. Additionally, such entities are expected to consider taking any appropriate steps for safeguarding and securing access to personal information and ensuring that others with access to personal information adhere to their privacy policies and procedures. Further, such entities may self-subject to evaluation by third parties to certify their adherence to widely-accepted privacy policies and practices. In addition, policies and practices are expected to be tailored for the particular types of personal information being gathered and/or accessed and tailored to applicable laws and standards, including jurisdiction-specific laws and standards which may impose a higher standard. For example, in the US, gathering of or access to health data may be governed by federal and/or state laws, such as the Health Insurance Portability and Accountability Act (HIPAA); and health data in other countries may be subject to other regulations and policies and is expected to be handled accordingly.

Despite the foregoing, the subject disclosure also understands that embodiments may be provided in which users are provided with options to block the use of, or access to, personal information. That is, the subject disclosure understands that hardware and/or software elements can be provided to prevent or block access to personal information. For example, in the case of providing an application-free XR environment, the subject technology may allow users to opt in or out of aspects that include the gathering and/or sharing of personal information, as a part of a registration process or any other time. In addition to providing options to opt in or out, the subject disclosure may include notifications relating to the personal information access or use. For example, a notification to a user may be provided upon downloading/installing an application that personal information will be accessed and then reminded before (e.g., immediately before) the application accesses personal information.

Moreover, the subject disclosure expects that personal information be handled and managed so as to minimize risks of unauthorized or unintentional use or access. Minimization of risk can include limiting data gathering and data deletion when the data is done being used. Additionally, and in applicable use cases, including for various health-related uses, data can be de-identified to protect the privacy of a user. Data de-identification can include, for appropriate use cases, removal of identifiers, managing a specificity or amount of data that is stored (e.g., gathering or storing locations at regional specificity instead of an address specificity or on an insufficient scale for recognition of faces or other personal features), managing storage of data (e.g., by storing data that is aggregated over multiple users), and/or differential privacy and/or other methods may be used.

Thus, while the subject disclosure broadly considers use of personal information in one or more implementations, the subject disclosure understands that various implementations can be implemented without access to personal information (i.e., implementations are disclosed that are not rendered inoperable due to the inaccessibility of personal information).

FIG. 12 illustrates an electronic system 1200 with which one or more implementations of the subject technology may be implemented. The electronic system 1200 can be, and/or can be a part of, the electronic device 105, the handheld electronic device 104, the electronic device 110, the electronic device 115, the smart speaker device 160, and/or the server 120 as shown in FIG. 1. The electronic system 1200 may include various types of computer readable media and interfaces for various other types of computer readable media. The electronic system 1200 includes a bus 1208, one or more processing unit(s) 1212, a system memory 1204 (and/or buffer), a ROM 1210, a permanent storage device 1202, an input device interface 1214, an output device interface 1206, and one or more network interfaces 1216, or subsets and variations thereof.

The bus 1208 collectively represents all system, peripheral, and chipset buses that communicatively connect the numerous internal devices of the electronic system 1200. In one or more implementations, the bus 1208 communicatively connects the one or more processing unit(s) 1212 with the ROM 1210, the system memory 1204, and the permanent storage device 1202. From these various memory units, the one or more processing unit(s) 1212 retrieves instructions to execute and data to process in order to execute the processes of the subject disclosure. The one or more processing unit(s) 1212 can be a single processor or a multi-core processor in different implementations.

The ROM 1210 stores static data and instructions that are needed by the one or more processing unit(s) 1212 and other modules of the electronic system 1200. The permanent storage device 1202, on the other hand, may be a read-and-write memory device. The permanent storage device 1202 may be a non-volatile memory unit that stores instructions and data even when the electronic system 1200 is off. In one or more implementations, a mass-storage device (such as a magnetic or optical disk and its corresponding disk drive) may be used as the permanent storage device 1202.

In one or more implementations, a removable storage device (such as a floppy disk, flash drive, and its corresponding disk drive) may be used as the permanent storage device 1202. Like the permanent storage device 1202, the system memory 1204 may be a read-and-write memory device. However, unlike the permanent storage device 1202, the system memory 1204 may be a volatile read-and-write memory, such as random access memory. The system memory 1204 may store any of the instructions and data that one or more processing unit(s) 1212 may need at runtime. In one or more implementations, the processes of the subject disclosure are stored in the system memory 1204, the permanent storage device 1202, and/or the ROM 1210 (which are each implemented as a non-transitory computer-readable medium). From these various memory units, the one or more processing unit(s) 1212 retrieves instructions to execute and data to process in order to execute the processes of one or more implementations.

The bus 1208 also connects to the input and output device interfaces 1214 and 1206. The input device interface 1214 enables a user to communicate information and select commands to the electronic system 1200. Input devices that may be used with the input device interface 1214 may include, for example, alphanumeric keyboards and pointing devices (also called “cursor control devices”). The output device interface 1206 may enable, for example, the display of images generated by electronic system 1200. Output devices that may be used with the output device interface 1206 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 12, the bus 1208 also couples the electronic system 1200 to one or more networks and/or to one or more network nodes, such as the electronic device 110 shown in FIG. 1, through the one or more network interface(s) 1216. In this manner, the electronic system 1200 can be a part of a network of computers (such as a LAN, a wide area network (“WAN”), or an Intranet, or a network of networks, such as the Internet. Any or all components of the electronic system 1200 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

In accordance with aspects of the disclosure, method is provided that includes providing, with an operating system of a computing device, an extended reality environment that includes a data visualization utility which, when activated, provides for presentation data of a plurality of data types within the extended reality environment; providing for presentation, with the operating system in the extended reality environment and independently of the data visualization utility, a respective set of interaction tools for interacting with data of each respective data type of the plurality of data types, where more than one of the sets of interaction tools and more than one of the interaction tools in each set of interaction tools are selectable for concurrent presentation in the extended reality environment; receiving, after providing the respective sets of the interaction tools for presentation, a selection of data of one of the plurality of data types for presentation with the data visualization utility; activating the data visualization utility responsive to receiving the selection; presenting the data of the one of the plurality of data types with the activated data visualization utility; and while the data of the one of the plurality of data types is being presented by the data visualization utility, receiving, from at least one sensor of the computing device, an input corresponding to an interaction tool of the respective set of interaction tools for the one of the plurality of data types, for user interaction with the data being presented.

In accordance with aspects of the disclosure, a computing device is provided that includes a memory storing an operating system, at least one sensor, and a plurality of sets of interaction tools; and at least one processor configured to: provide, with the operating system, an extended reality environment that includes a data visualization utility which, when activated, provides for presenting data of a plurality of data types within the extended reality environment; provide for presentation, with the operating system in the extended reality environment and independently of the data visualization utility, a respective set of the interaction tools for interacting with data of each respective data type of the plurality of data types, where more than one of the sets of interaction tools and more than one of the interaction tools in each set of interaction tools are selectable for concurrent presentation in the extended reality environment; receive, after providing the respective sets of the interaction tools for presentation, a selection of data of one of the plurality of data types for presentation with the data visualization utility; activate the data visualization utility responsive to receiving the selection; present the data of the one of the plurality of data types with the activated data visualization utility; and, while the data of the one of the plurality of data types is being presented by the data visualization utility, receive, from the at least one sensor, an input corresponding to an interaction tool of the respective set of interaction tools for the one of the plurality of data types, for user interaction with the data being presented.

In accordance with aspects of the disclosure, non-transitory computer-readable medium is provided, storing instructions which, when executed by one or more processors, cause the one or more processors to perform operations, that include: providing, with an operating system of a computing device, an extended reality environment that includes a data visualization utility which, when activated, provides for presenting data of a plurality of data types within the extended reality environment; providing for presentation, with the operating system in the extended reality environment and independently of the data visualization utility, a respective set of interaction tools for interacting with data of each respective data type of the plurality of data types, where more than one of the sets of interaction tools and more than one of the interaction tools in each set of interaction tools are selectable for concurrent presentation in the extended reality environment; receiving, after providing the respective sets of the interaction tools for presentation, a selection of data of one of the plurality of data types for presentation with the data visualization utility; activating the data visualization utility responsive to receiving the selection; presenting the data of the one of the plurality of data types with the activated data visualization utility; and, while the data of the one of the plurality of data types is being presented by the data visualization utility, receiving, from at least one sensor of the computing device, an input corresponding to an interaction tool of the respective set of interaction tools for the one of the plurality of data types, for user interaction with the data being presented.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

1. A method, comprising:
providing, with an operating system of a computing device, an extended reality environment that comprises a data visualization utility which, when activated, provides for presenting data of a plurality of data types within the extended reality environment;
providing for presentation, with the operating system in the extended reality environment and independently of the data visualization utility, a respective set of interaction tools for interacting with data of each respective data type of the plurality of data types, wherein more than one of the sets of interaction tools and more than one of the interaction tools in each of the more than one of the sets of interaction tools are selectable for concurrent presentation in the extended reality environment;
receiving, after providing the respective sets of the interaction tools for presentation, a selection of data of one of the plurality of data types for presentation with the data visualization utility;
activating the data visualization utility responsive to receiving the selection;
presenting the data of the one of the plurality of data types with the activated data visualization utility; and
while the data of the one of the plurality of data types is being presented by the data visualization utility, receiving, from at least one sensor of the computing device, an input corresponding to an interaction tool of the respective set of interaction tools for the one of the plurality of data types, for user interaction with the data being presented.

2. The method of claim 1, wherein first and second sets of the sets of interaction tools are, prior to the operating system providing the respective set of the interaction tools for interacting with the data of each respective data type of the plurality of data types for presentation, provided to the computing device, respectively, by first and second interaction tool providers, at least one of the first and second interaction tool providers being different from a provider of the operating system.

3. The method of claim 2, wherein the interaction tool of the respective set of interaction tools for the one of the plurality of data types is a first interaction tool of the first set, and wherein a second interaction tool of the second set is concurrently presented for use in interacting with the data of the one of the plurality of data types being presented by the data visualization utility.

4. The method of claim 3, wherein the extended reality environment is a three-dimensional extended reality environment, and wherein the method further comprises presenting the interaction tool of the respective set of interaction tools with a three-dimensional appearance in the three-dimensional extended reality environment, the three-dimensional appearance corresponding to a physical shape of a corresponding physical tool.

5. (canceled)

6. The method of claim 4, wherein receiving the selection of the data of one of the plurality of data types comprises receiving the selection with the interaction tool of the respective set of interaction tools.

7. The method of claim 6, further comprising concurrently presenting the interaction tool of the respective set of interaction tools and at least another of the interaction tools of the respective set of interaction tools in the extended reality environment for modifying the data of the one of the plurality of data types being presented by the data visualization utility.

8. The method of claim 1, wherein the extended reality environment is an application-free environment.

9. The method of claim 1, further comprising, while presenting the data of the one of the plurality of data types with the activated data visualization utility at a first location in the extended reality environment, presenting data of another one of the plurality of data types with the data visualization utility at a second location in the extended reality environment.

10. The method of claim 9, further comprising, while the data of the one of the other one of the plurality of data types is being presented by the data visualization utility at the second location:
presenting an interaction tool of the respective set of interaction tools for the other one of the plurality of data types in the extended reality environment;
receiving a user selection of the interaction tool of the respective set of interaction tools for the other one of the plurality of data types; and
receiving, from the at least one sensor of the computing device, a user input corresponding to an interaction, using the selected interaction tool of the respective set of interaction tools for the other one of the plurality of data types, with the data of the one of the other one of the plurality of data types that is being presented by the data visualization utility at the second location.

11. The method of claim 10, wherein the interaction tool of the respective set of interaction tools for the other one of the plurality of data types is the same as the interaction tool of the respective set of interaction tools for the one of the plurality of data types.

12. The method of claim 10, wherein the interaction tool of the respective set of interaction tools for the other one of the plurality of data types is different from the interaction tool of the respective set of interaction tools for the one of the plurality of data types.

13. The method of claim 9, further comprising:
receiving, from the at least one sensor of the computing device, an input corresponding to the interaction tool of the respective set of interaction tools for the one of the plurality of data types, for user interaction with the data of the one of the plurality of data types at the first location; and
receiving, from the at least one sensor of the computing device, an input corresponding to the same interaction tool of the respective set of interaction tools for the one of the plurality of data types, for user interaction with the data of the other one of the plurality of data types at the second location.

14. The method of claim 1, further comprising:
deactivating the data visualization utility; and
removing the respective set of interaction tools from presentation in the extended reality environment.

15. The method of claim 14, further comprising:
receiving an additional selection of data of another one of the plurality of data types for presentation with the data visualization utility;
activating the data visualization utility responsive to receiving the additional selection;
presenting the data of the other one of the plurality of data types with the activated data visualization utility; and
providing, for presentation, at least one interaction tool for interaction with the data of the other one of the plurality of data types after presenting the data of the other one of the plurality of data types with the activated data visualization utility.

16. A computing device, comprising:
a memory storing an operating system and a plurality of sets of interaction tools;
at least one sensor; and
at least one processor configured to:
provide, with the operating system, an extended reality environment that comprises a data visualization utility which, when activated, provides for presenting data of a plurality of data types within the extended reality environment;
provide for presentation, with the operating system in the extended reality environment and independently of the data visualization utility, a respective set of the interaction tools for interacting with data of each respective data type of the plurality of data types, wherein more than one of the plurality of sets of interaction tools and more than one of the interaction tools in each of the more than one of the sets of interaction tools are selectable for concurrent presentation in the extended reality environment;
receive, after providing the respective sets of the interaction tools for presentation, a selection of data of one of the plurality of data types for presentation with the data visualization utility;
activate the data visualization utility responsive to receiving the selection;
present the data of the one of the plurality of data types with the activated data visualization utility; and
while the data of the one of the plurality of data types is being presented by the data visualization utility, receive, from the at least one sensor, an input corresponding to an interaction tool of the respective set of interaction tools for the one of the plurality of data types, for user interaction with the data being presented.

17. The computing device of claim 16, wherein, prior to the operating system providing the respective set of the interaction tools for interacting with the data of each respective data type of the plurality of data types for presentation, first and second sets of the sets of interaction tools are obtained by the computing device, respectively, from first and second interaction tool providers, at least one of the first and second interaction tool providers being different from a provider of the operating system.

18. The computing device of claim 17, wherein the interaction tool of the respective set of interaction tools for the one of the plurality of data types is a first interaction tool of the first set, and wherein a second interaction tool of the second set is concurrently presented for use in interacting with the data of the one of the plurality of data types being presented by the data visualization utility.

19-23. (canceled)

24. The computing device of claim 16, wherein the at least one processor is further configured to, while presenting the data of the one of the plurality of data types with the activated data visualization utility at a first location in the extended reality environment, present data of another one of the plurality of data types with the data visualization utility at a second location in the extended reality environment.

25. The computing device of claim 24, wherein the at least one processor is further configured to, while the data of the one of the other one of the plurality of data types is being presented by the data visualization utility at the second location:
present an interaction tool of the respective set of interaction tools for the other one of the plurality of data types in the extended reality environment;
receive a user selection of the interaction tool of the respective set of interaction tools for the other one of the plurality of data types; and
receive, from the at least one sensor, an input corresponding to an interaction, using the selected interaction tool of the respective set of interaction tools for the other one of the plurality of data types, with the data of the one of the other one of the plurality of data types that is being presented by the data visualization utility at the second location.

26-27. (canceled)

28. The computing device of claim 24, wherein the at least one processor is further configured to:
receive, from the at least one sensor, an input corresponding to the interaction tool of the respective set of interaction tools for the one of the plurality of data types, for user interaction with the data of the one of the plurality of data types at the first location; and
receive, from the at least one sensor, an input corresponding to the same interaction tool of the respective set of interaction tools for the one of the plurality of data types, for user interaction with the data of the other one of the plurality of data types at the second location.

29-30. (canceled)

31. A non-transitory computer-readable medium storing instructions which, when executed by one or more processors, cause the one or more processors to perform operations, comprising:
providing, with an operating system of a computing device, an extended reality environment that comprises a data visualization utility which, when activated, provides for presenting data of a plurality of data types within the extended reality environment;
providing for presentations, with the operating system in the extended reality environment and independently of the data visualization utility, a respective set of interaction tools for interacting with data of each respective data type of the plurality of data types, wherein more than one of the sets of interaction tools and more than one of the interaction tools in each of the more than one of the sets of interaction tools are selectable for concurrent presentation in the extended reality environment;
receiving, after providing the respective sets of the interaction tools for presentation, a selection of data of one of the plurality of data types for presentation with the data visualization utility;
activating the data visualization utility responsive to receiving the selection;
presenting the data of the one of the plurality of data types with the activated data visualization utility; and
while the data of the one of the plurality of data types is being presented by the data visualization utility, receiving, from at least one sensor of the computing device, an input corresponding to an interaction tool of the respective set of interaction tools for the one of the plurality of data types, for user interaction with the data being presented.

32. The non-transitory computer-readable medium of claim 31, wherein, prior to the operating system providing the respective set of the interaction tools for interacting with the data of each respective data type of the plurality of data types for presentation, first and second sets of the sets of interaction tools are provided to the computing device, respectively, by first and second interaction tool providers, at least one of the first and second interaction tool providers being different from a provider of the operating system.

33-38. (canceled)

39. The non-transitory computer-readable medium of claim 31, the operations further comprising, while presenting the data of the one of the plurality of data types with the activated data visualization utility at a first location in the extended reality environment, presenting data of another one of the plurality of data types with the data visualization utility at a second location in the extended reality environment.

40. The non-transitory computer-readable medium of claim 39, the operations further comprising, while the data of the one of the other one of the plurality of data types is being presented by the data visualization utility at the second location:
presenting an interaction tool of the respective set of interaction tools for the other one of the plurality of data types in the extended reality environment;
receiving a user selection of the interaction tool of the respective set of interaction tools for the other one of the plurality of data types; and
receiving, from the at least one sensor, an input corresponding to an interaction, using the selected interaction tool of the respective set of interaction tools for the other one of the plurality of data types, with the data of the one of the other one of the plurality of data types that is being presented by the data visualization utility at the second location.

41-42. (canceled)

43. The non-transitory computer-readable medium of claim 39, the operations further comprising:
receiving, from the at least one sensor, an input corresponding to the interaction tool of the respective set of interaction tools for the one of the plurality of data types, for user interaction with the data of the one of the plurality of data types at the first location; and
receiving, from the at least one sensor, an input corresponding to the same interaction tool of the respective set of interaction tools for the one of the plurality of data types, for user interaction with the data of the other one of the plurality of data types at the second location.

44-45. (canceled)
